(19) United States
(12) Patent Application Publication
(10) Pub. No.: US 2008/0124439 A1
(43) Pub. Date: May 29, 2008

(54) Nutritional supplement composition comprising creatine and method for making the same

(76) Inventor: Mohammad Nuralam, Bronx, NY (US)

Correspondence Address: Allen R. Kipnes, Esq.;WATOV & KIPNES, P.C., P.O. Box 247, Princeton Junction, NJ, 08550, US

(21) Appl. No.: 11/604,562

(22) Filed: Nov. 27, 2006

(51) Int. Cl. A23L 1/29; A23L 1/48

(52) U.S. Cl. 426/506; 426/648

(57) ABSTRACT

A nutritional supplement composition includes creatine or a derivative thereof, a stabilizing mixture comprising at least one diol and at least one polyol, sufficient to render the creatine therein at least substantially stable, and an aqueous medium. The present invention is further directed to a method of making the same.

### FIELD OF THE INVENTION

The present invention relates generally to nutritional supplements, and more particularly to a nutritional supplement composition comprising creatine effectively stabilized for prolonged periods of time.

### BACKGROUND OF THE INVENTION

Creatine is an amino acid produced naturally in the liver and kidneys and obtained from food such as meat and fish. Creatine functions as part of the cell's energy shuttle. The high energy phosphate group of adenosine triphosphate (ATP) is transferred to creatine to form phosphocreatine. This reaction is reversibly catalyzed by creatine kinase, also referred to as creatine phosphokinase. At sites of high energy usage, such as at the site of muscle contraction, creatine kinase transfers the high energy phosphate back from phosphocreatine to adenosine diphosphate (ADP) to reform ATP. This allows the cellular ATP/ADP ratio to remain stable within the cell, even if it is undergoing rapid energy fluctuations. Creatine kinase is typically located in cells that undergo high energy fluctuations. The presence of this energy shuttle keeps the ATP/ADP ratio high, which ensures that the free energy of ATP remains high and minimizes loss of adenosine nucleotides, which would cause cellular dysfunction.

Various commercial products containing creatine, typically creatine monohydrate, are available. A number of methods of ingestion exist, for example, as a powder mixed into a drink, or a pill. Creatine supplementation has been investigated as a possible approach for the treatment of muscular, neurological and neuromuscular diseases. Athletes commonly use food supplements containing creatine monohydrate as part of their training regimen. The food supplements allow athletes to train harder, and greatly enhance muscle size and strength. Therefore, creatine is often taken as a supplement for those wishing to gain muscle mass. Creatine has recently been observed to play a role in maintaining energy levels in the brain for enhanced memory and mental performance. It is possible that individuals including elderly persons, strict vegetarians or those who eat little or no meat or fish, would benefit the most from creatine supplementation, since they tend to have relatively low levels of muscle creatine.

There are a number of forms of creatine, however the most common is creatine monohydrate which is creatine bonded to a molecule of water. A newer form of creatine is creatine ethyl ester (CEE), which is creatine monohydrate with an ester attached. Creatine ethyl ester comprises a molecule of creatine bonded synthetically by the addition of ethyl alcohol and an acid to the molecule. CEE is believed to exhibit enhanced absorption rates in the human body, tens of times higher than creatine monohydrate. Further details on creatine esters and the making of the same, may be found in U.S. Pat. No. 6,897,334, the content of which is incorporated herein by reference.

Nutritional supplements in the form of a solution or ready to drink beverage provide a convenient form of ingestion for creatine. However, creatine dispersed in an aqueous solution is known to be very unstable, especially at acidic pH levels (i.e., below pH 7). Creatine is also poorly soluble in an aqueous solution, and tends to convert to creatinine, an undesirable by-product. This presents a problem in providing an effective liquid composition containing creatine in a usable form and in physiologically useful amounts.

Furthermore, creatine is not well absorbed from the gastrointestinal tract. Creatine also has low oral bioavailability due, in part, to low lipophilicity and therefore poor membrane permeability, and exhibits rapid conversion to creatinine in the acidic environment of the stomach. Thus, current products require administration of large amounts of creatine in order to be effective, which unfortunately causes adverse side effects such as bloating, gastrointestinal distress, diarrhea, cramping, dehydration, and the like.

Accordingly, there is a need to develop a nutritional supplement composition that is capable of effectively delivering creatine in a usable form and in physiologically useful amounts to the body in a manner that substantially avoids the problems experienced in the prior art. Further, there is a need for a nutritional supplement composition comprising creatine, preferably, in the form of a liquid such as a ready to drink beverage, which is stable for prolonged periods of time.

### SUMMARY OF THE INVENTION

The present invention relates generally to a nutritional supplement composition containing creatine formulated for enhancing the chemical stability and bioavailability of creatine. The nutritional supplement composition of the present invention is further formulated to render the creatine therein at least substantially stable in the presence of an aqueous medium. The nutritional supplement composition of the present invention is preferably in the form of a liquid that may be administered orally for convenience and ease of administration. The nutritional supplement composition of the present invention is formulated to provide creatine for various potential health enhancing benefits including better memory and mental performance, enhanced muscle size or strength, improved muscular, neurological and neuromuscular function, and the like. The present invention is effective for supplementing the diet of the consumer and enhancing the consumer's health.

In one aspect of the present invention, there is provided a nutritional supplement composition comprising creatine or a derivative thereof, a stabilizing mixture comprising at least one diol and at least one polyol, sufficient to render the creatine therein at least substantially stable, and an aqueous medium.

In another aspect of the present invention, there is provided a method for producing the above nutritional supplement composition, comprising preparing a creatine mixture comprising creatine or a derivative thereof and an aqueous medium, preparing a polyol mixture comprising a polyol and an aqueous medium, and blending a sufficient amount of a diol and the polyol mixture with the creatine mixture together to render the creatine therein at least substantially stable.

### DETAILED DESCRIPTION OF THE INVENTION

The present invention is directed to a nutritional supplement composition comprising creatine or derivative thereof stabilized by a stabilizing mixture in an aqueous medium. Creatine and derivatives thereof, including creatine monohydrate and creatine ethyl ester (CEE), are known to improve and enhance health of individuals. Such health enhancing benefits may include better memory and mental performance, enhanced muscle size or strength, improved muscular, neurological and neuromuscular function, and the like.

The nutritional supplement compositions and methods of the present invention provides further and significant health improvements as compared to prior art products and methods employing only creatine or a hydrate thereof in an aqueous medium. The nutritional supplement compositions of the present invention substantially extend the stability of the creatine contained therein for greater bioavailablity and enhanced delivery and absorption into the body of the consumer.

The nutritional supplement composition of the present invention is specifically formulated to render the creatine therein at least substantially stable in an aqueous medium. The nutritional supplement composition of the present invention is preferably in the form of a liquid that may be administered orally for convenience and ease of administration. The present invention is effective for supplementing the diet of the consumer and enhancing the consumer's health.

In one embodiment of the present invention, there is provided a nutritional supplement composition comprising creatine or a derivative thereof, a stabilizing mixture comprising at least one diol and at least one polyol, sufficient to render the creatine therein at least substantially stable, and an aqueous medium.

The term “creatine or a derivative thereof” is intended to encompass creatine and derivatives thereof including esters, hydrates, salts, lactones and complexes thereof. Suitable salts include, but are not limited to, alkali and alkaline earth metal salts, for example, sodium, potassium or calcium salts, while suitable esters include, but are not limited to, alkyl esters, for example, methyl, ethyl, or propyl esters, or lactone esters. Commercially available creatine derivatives include creatine monohydrate, other creatine hydrates, creatine citrate, creatine pyruvate, and creatine esters. Preferred creatine and derivatives thereof are creatine esters, more preferred are creatine alkyl esters, and most preferred is creatine ethyl ester.

The creatine or a derivative thereof, which is employed in the nutritional supplement compositions of the present invention, including creatine ethyl ester, may be commercially available from various sources. It is also preferred that the creatine and derivatives thereof are a pharmaceutical-grade material.

The creatine or derivative thereof is incorporated in an amount of at least 0.1% by weight based on the total weight of the present composition, preferably ranging from about 5% to 95% by weight, and more preferably from about 10% to 50% by weight.

The nutritional supplement composition of the present invention further comprises a stabilizing mixture comprising at least one diol and at least one polyol, sufficient to render the creatine therein at least substantially stable, and an aqueous medium. The stabilizing mixture in the present composition has been observed to substantially enhance the stability and bioavailability of creatine in the presence of the aqueous medium.

As used herein, the term “diol” is intended to encompass any compound safe for human consumption containing two hydroxyl groups. In a preferred embodiment, the diol employed in the nutritional supplement composition of the present invention is selected from a glycol. Suitable glycols include propylene glycol, butylene glycol, and combinations thereof. A preferred glycol is propylene glycol. The diol is typically present in the composition in an amount of from about 0.1% to 40% by weight based on the total weight of the composition, preferably from about 5% to 30% by weight based on the total weight of the composition, and more preferably from about 10% to 20% by weight based on the total weight of the composition.

As used herein, the term “polyol” encompasses any compound safe for human consumption containing three or more hydroxyl groups including sugar alcohols. Suitable sugar alcohols include, but are not limited to, sorbitol, maltitol, xylitol, isomalt, lactitol, erythritol, glycerol, mannitol, and combinations thereof. A preferred sugar alcohol is sorbitol. The polyol is typically present in the composition in an amount of from about 0.1% to 60% by weight based on the total weight of the composition, preferably from about 5% to 40% by weight based on the total weight of the composition, and more preferably from about 10% to 30% by weight based on the total weight of the composition.

In a preferred embodiment of the present invention, the nutritional supplement composition is in the form of a liquid or ready to drink beverage for oral consumption by the consumer. It is noted that solutions are preferred for oral administration, since ingredients in solution are more rapidly absorbed. Solutions are also often more acceptable to consumer especially in terms of palatability.

The term “at least substantially stable” refers to a composition in which at least 90% of the original creatine in the composition is unchanged for a period of at least 6 months storage at about ambient temperature (˜20° C. to 25° C.). Preferably, the composition of the present invention is sufficiently stable that 90% of the creatine remains following a period of at least one year, and more preferably at least two years at about ambient temperature.

The composition may further include one or more ingredients for improving the palatability, stability, flavor or nutritive quality of the present compositions, in varying amounts, depending upon the effect desired. Such ingredients may include electrolytes, or may be selected from the group consisting of: vitamins, lipids, carbohydrates, amino acids, trace elements, colorings, flavors, artificial sweeteners, natural health improving substances, anti-oxidants, stabilizers, preservatives, and buffers. The composition may be unflavored or where the ingredient is a recognized foodstuff (e.g. honey or syrup), the composition may have the normal flavor of the ingredient.

Examples of such ingredients may include protein isolate, magnesium chloride, potassium citrate, calcium phosphate tribasic, soy lecithin, sodium citrate, choline chloride, ascorbic acid, taurine, L-carnitine, zinc sulfate, ferrous sulfate, alpha-tocopherol acetate, niacinamide, carrageenin, calcium pantothenate, manganese sulphate, thiamine chloride hydrochloride, pyridoxine hydrochloride, riboflavin, copper sulphate, vitamin A palmitate, folic acid, biotin, sodium molybdate, chromium chloride, potassium iodide, sodium selenate, phylloquinone, cyanocobalamin, vitamins A, thiamin (B₁), riboflavin (B₂), B₆, B₁₂, D, D₂, E and K, folic acid, niacin, choline, biotin, pantothenic acid and the like. The nutritional ingredients may be added in amounts ranging from about 20% to 100% of their recommended daily allowance (RDA).

Preservatives can be typically selected from sodium benzoate, potassium sorbate, methylparaben, propylparaben, and the like. The preservative is typically present in the composition in an amount of from about 0.1% to 0.6% by weight based on the total weight of the composition, preferably from about 0.30% to 0.45% by weight based on the total weight of the composition, and more preferably from about 0.15% to 0.30% by weight based on the total weight of the composition.

Bulk sweeteners include both sugar and sugarless components. Sugar sweeteners generally include saccharide-containing components commonly known in the art, including but not limited to, sucrose, dextrose, maltose, dextrin, dried invert sugar, fructose, levulose, glactose, corn syrup solids, and the like, alone or in combination. High-intensity artificial sweeteners can also be used, alone or in combination, with the above. Preferred sweeteners include, but are not limited to, sucralose, aspartame, salts of acesulfame, altitame, saccharin and its salts, cyclamic acid and its salts, glycerrhizinate, dihydrochalcones, thaumatin, monellin, and the like, alone or in combination. The bulk sweetener is typically present in the composition in an amount of from about 5% to 95% by weight based on the total weight of the composition, preferably from about 20% to 40% by weight based on the total weight of the composition, and more preferably from about 15% to 30% by weight based on the total weight of the composition.

A variety of flavoring agents can also be used, if desired. Flavoring agents may include essential oils, natural or synthetic flavors or mixtures thereof including, but not limited to, oils derived from plants and fruits such as citrus oils, fruit essences, peppermint oil, spearmint oil, other mint oils, clove oil, oil of wintergreen, anise, fruity flavors such as berry, lemon, orange, papaya and grapefruit and the like. Artificial flavoring agents and components may also be used. Natural and artificial flavoring agents may be combined in any acceptable manner. Citric acid may also be used as an acidulant and citrate (e.g. sodium citrate) as a buffering agent. The flavoring agent is typically present in the composition in an amount of from about 0.1% to 15% by weight based on the total weight of the composition, preferably from about 0.2% to 5% by weight based on the total weight of the composition, and more preferably from about 0.2% to 0.5% by weight based on the total weight of the composition.

Viscosity modifiers such as xanthan gum may be added to the present composition to adjust the viscosity. The viscosity modifier is typically present in the composition in an amount of from about 0.01% to 5% by weight based on the total weight of the composition, preferably from about 0.1% to 2% by weight based on the total weight of the composition, and more preferably from about 0.1% to 0.5% by weight based on the total weight of the composition.

Coloring can be provided, typically by using a cold water soluble colorant such as beta-carotene. Other suitable colorings will be apparent to those skilled in the art.

The mineral and trace elements can also be added in any type or form which is suitable for human consumption. It is convenient to provide the calcium and potassium in the form of their gluconates, phosphates or hydrogen phosphates, and magnesium as the oxide or carbonate, chromium as chromium picolmate, selenium as sodium selenite or selenate, and zinc as zinc gluconate.

In another embodiment of the present invention, there is provided a method for producing the nutritional supplement composition of the present invention, comprising preparing a creatine mixture comprising creatine or a derivative thereof and an aqueous medium, preparing a polyol mixture comprising a polyol and an aqueous medium, and blending a sufficient amount of a diol and the polyol mixture with the creatine mixture together to render the creatine therein at least substantially stable. Preferably the aqueous medium is water or an aqueous solution.

In a preferred embodiment of the present invention, there is provided a method for producing the nutritional supplement composition of the present invention, comprising adding creatine or a derivative thereof, preferably creatine ester and more preferably creatine ethyl ester to an aqueous medium to yield a creatine mixture. The creatine mixture is then blended for about 30 minutes and is maintained at a temperature of about less than 40° C., and preferably from about 8° C. to 38° C. The creatine mixture is maintained at the prescribed temperature to minimize or avoid aggregation and clumping of the creatine.

A solution of at least one polyol preferably selected from sugar alcohol is prepared. Suitable sugar alcohols include, but are not limited to, sorbitol, maltitol, xylitol, isomalt, lactitol, erythritol, glycerol, mannitol, and combinations thereof. A particularly preferred sugar alcohol is sorbitol. The creatine mixture is thereafter thoroughly mixed very slowly with the polyol solution along with at least one diol selected from a glycol. Suitable glycols include propylene glycol, butylene glycol, and combinations thereof. A particularly preferred glycol is propylene glycol.

The diol and the polyol solution is mixed with the creatine mixture for about 30 minutes. Thereafter, a bulk sweetener such as fructose is added very slowly to the resulting mixture. Preservatives comprising, for example, sodium benzoate and potassium sorbate are added to the resulting mixture and mixed for about 30 minutes. A flavoring agent is then added to the resulting mixture. The resulting mixture is mixed for about 15 minutes prior to adding a viscosity modifier such as xanthan gum. The resulting mixture is blended from about 25 minutes.

The nutritional supplement composition of the present invention may be consumed in effective amounts at any convenient time to enhance or maintain the quantity of intracellular creatine. However, best results may be obtained by consuming the composition immediately after a period of exercise.

The nutritional supplement compositions of the present invention may be employed in methods for supplementing the diet of a consumer to provide better memory and mental performance, enhanced muscle size or strength, improved muscular, neurological and neuromuscular function or simply boost creatine content in the body for overall health benefits. Administration of an “effective amount” of the supplements and substances of the present invention is defined as an amount effective, at dosages and for periods of time necessary to achieve the desired result. The effective amount of the supplements of the invention may vary according to factors such as the age, sex, and weight of the consumer. Dosage regimen may be adjusted to provide the optimum response: Several divided doses may be administered daily or the dose may be proportionally reduced as indicated by the exigencies of the individual consumer situation.

As discussed, the amount of the nutritional supplement composition which is administered to the diet of the consumer may vary depending on the desired effect, the body weight and characteristics of the consumer, and the like. For example, in preferred methods for supplementing the diet of an athlete and/or for enhancing an athlete's muscle size or strength, from about 1 ml to 1000 ml of a nutritional supplement composition of the present invention are administered to the diet of the athlete on a daily basis.

In more preferred embodiments of these methods, from about 5 ml to 20 ml, and more preferably about 15 mL of a nutritional supplement composition of the present invention are administered to the diet of the athlete on a daily basis. The amount and frequency per day will depend upon the formulation of the composition.

As will be readily appreciated a nutritional supplement composition in accordance with the present invention may be administered in a single serving or in multiple servings spaced throughout the day. In a preferred embodiment, a nutritional supplement composition in accordance with the present invention may be administered once in the morning, once immediately or shortly after training and once in the evening on a daily basis.

In order to maximize the effects of a nutritional supplement composition of the present invention, in enhancing muscle size and/or strength, it is preferred that the nutritional supplement composition is administered to the diet of the athlete immediately following an exercise period. On non-workout days, the nutritional supplement composition may be administered anytime during the day, although administering a first amount of a food supplement upon awakening or otherwise during the morning hours is preferred.

### EXAMPLE 1

### A Creatine Ethyl Ester Composition of the Present Invention

A creatine ethyl ester composition was formulated to provide 5 grams of creatine in a 15 mL dose amount. The ingredients of the composition are listed in Table 1 below.

TABLE 1

| Ingredients | Weight | Unit | % (w/w) |
|---|---|---|---|
| Purified water | 4660.77 | mg | 31.07 |
| Sorbitol solution (70% sorbitol) | 2949.85 | mg | 19.67 |
| Propylene glycol | 1401.18 | mg | 9.34 |
| Creatine ethyl ester | 3687.32 | mg | 24.58 |
| Sodium benzoate | 22.12 | mg | 0.15 |
| Potassium sorbate | 22.12 | mg | 0.15 |
| Fructose | 2212.39 | mg | 14.75 |
| Proprietary flavor blend | 29.50 | mg | 0.20 |
| Xanthan gum | 14.75 | mg | 0.09 |
| | 15,000 | mg | 100 |

All the necessary equipment and utensils, were gathered, cleaned and sanitized according to standard sanitization procedures. The equipment was assembled and log takes were performed and recorded on the corresponding equipment log books.

Purified water was added to a suitable stainless steel mixing tank and mixed for at least 5 minutes. During the mixing, creatine ethyl ester was slowly added to the purified water. The resulting mixture was blended for about 30 minutes. The temperature of the resulting mixture was maintained below 35° C. In the event the temperature exceeded 35° C., the mixing is suspended to prevent potential aggregation of the creatine.

During mixing of the mixture, the sorbitol solution and propylene glycol were added very slowly. The resulting mixture was mixed for about 30 minutes. Fructose was then added very slowly. Sodium benzoate and potassium sorbate were then added to the resulting mixture and mixed for about 30 minutes. Then the flavor blend was added to the mixture and mixed for about 15 minutes. During mixing, xanthan gum was added to the mixture and mixed for a sufficient time to blend the gum. The mixture was blended for about 25 minutes and the temperature was maintained below 32° C. The volume of the resulting mixture was adjusted by adding water and mixed for about 30 minutes.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A nutritional supplement composition comprising creatine or a derivative thereof, a stabilizing mixture comprising at least one diol and at least one polyol, sufficient to render the creatine therein at least substantially stable, and an aqueous medium.

2. The nutritional supplement composition of claim 1 wherein the creatine derivative is a creatine ester.

3. The nutritional supplement composition of claim 2 wherein the creatine ester is a creatine alkyl ester.

4. The nutritional supplement composition of claim 3 wherein the creatine alkyl ester is creatine ethyl ester.

5. The nutritional supplement composition of claim 4 wherein the diol is a glycol.

6. The nutritional supplement composition of claim 5 wherein the glycol is selected from the group consisting of propylene glycol, butylene glycol, and combinations thereof.

7. The nutritional supplement composition of claim 6 wherein the glycol is propylene glycol.

8. The nutritional supplement composition of claim 1 wherein the polyol is a sugar alcohol.

9. The nutritional supplement composition of claim 8 wherein the sugar alcohol is selected from the group consisting of sorbitol, maltitol, xylitol, isomalt, lactitol, erythritol, glycerol, mannitol, and combinations thereof.

10. The nutritional supplement composition of claim 9 wherein the sugar alcohol is sorbitol.

11. The nutritional supplement composition of claim 1 wherein the creatine or derivative thereof is present in an amount of at least 0.1% by weight based on the total weight of the composition.

12. The nutritional supplement composition of claim 11 wherein the creatine or derivative thereof is present in an amount of from about 5% to 95% by weight based on the total weight of the composition.

13. The nutritional supplement composition of claim 12 wherein the creatine or derivative thereof is present in an amount of from about 10% to 50% by weight based on the total weight of the composition.

14. The nutritional supplement composition of claim 1 wherein the creatine or derivative thereof is present in an amount of from about 0.1% to 95% by weight based on the total volume of the composition.

15. The nutritional supplement composition of claim 14 wherein the creatine or derivative thereof is present in an amount of from about 5% to 80% by weight based on the total volume of the composition.

16. The nutritional supplement composition of claim 15 wherein the creatine or derivative thereof is present in an amount of from about 10% to 50% by weight based on the total volume of the composition.

17. The nutritional supplement composition of claim 1 wherein the diol is present in an amount of from about 0.1% to 40% by weight based on the total weight of the composition.

18. The nutritional supplement composition of claim 17 wherein the diol is present in an amount of from about 5% to 30% by weight based on the total weight of the composition.

19. The nutritional supplement composition of claim 18 wherein the diol is present in an amount of from about 10% to 20% by weight based on the total weight of the composition.

20. The nutritional supplement composition of claim 1 wherein the polyol is present in an amount of from about 0.1% to 60% by weight based on the total weight of the composition.

21. The nutritional supplement composition of claim 20 wherein the polyol is present in an amount of from about 5% to 40% by weight based on the total weight of the composition.

22. The nutritional supplement composition of claim 21 wherein the polyol is present in an amount of from about 10% to 30% by weight based on the total weight of the composition.

23. The nutritional supplement composition of claim 1 wherein at least 90% of creatine or the derivative thereof remains unchanged for a period of at least one year at about ambient temperature.

24. The nutritional supplement composition of claim 1 wherein at least 90% of creatine or the derivative thereof remains unchanged for a period of at least two years at about ambient temperature.

25. A method for producing the nutritional supplement composition of claim 1, comprising preparing a creatine mixture comprising creatine or a derivative thereof and an aqueous medium, preparing a polyol mixture comprising a polyol and an aqueous medium, and blending a sufficient amount of a diol and the polyol mixture with the creatine mixture together to render the creatine therein at least substantially stable.

26. The method of claim 26 further comprising maintaining the temperature of the creatine mixture to prevent undesirable aggregation.

27. The method of claim 27 wherein the temperature is less that 40° C.

28. The method of claim 28 wherein the temperature is in the range of from about 8° C. to 38° C.

29. The method of claim 26 wherein the creatine derivative is a creatine ester.

30. The nutritional supplement composition of claim 30 wherein the creatine ester is a creatine alkyl ester.

31. The nutritional supplement composition of claim 31 wherein the creatine alkyl ester is creatine ethyl ester.

32. The method of claim 26 wherein the diol is a glycol.

33. The method of claim 33 wherein the glycol is selected from the group consisting of propylene glycol, butylene glycol, and combinations thereof.

34. The method of claim 34 wherein the glycol is propylene glycol.

35. The method of claim 26 wherein the polyol is a sugar alcohol.

36. The method of claim 36 wherein the sugar alcohol is selected from the group consisting of sorbitol, maltitol, xylitol, isomalt, lactitol, erythritol, glycerol, mannitol, and combinations thereof.

37. The method of claim 37 wherein the sugar alcohol is sorbitol.
